(19) United States
(12) Patent Application Publication
(10) Pub. No.: US 2025/0321103 A1
(43) Pub. Date: Oct. 16, 2025

(54) POSITION MEASURING DEVICE AND METHOD

(71) Applicant: Azbil Corporation, Tokyo (JP)

(72) Inventors: Yasuhiro KOGISO, Tokyo (JP); Itsuki TANABE, Tokyo (JP); Fumiaki YAMASAKI, Tokyo (JP)

(73) Assignee: Azbil Corporation, Tokyo (JP)

(21) Appl. No.: 19/172,572

(22) Filed: Apr. 7, 2025

(30) Foreign Application Priority Data
Apr. 10, 2024 (JP) 2024-063275

(51) Int. Cl. G01C 21/16; G01C 25/00; G01M 13/003; G01P 7/00; G01P 21/00

(52) U.S. Cl. CPC G01C 21/16; G01C 25/00; G01P 7/00; G01P 21/00; G01M 13/003

(57) ABSTRACT

A position measuring device includes: a first sensor, measuring acceleration or angular velocity of a valve stem of an ON-OFF valve; a position information generation part, integrating the acceleration or angular velocity measured by the first sensor and converting the acceleration or angular velocity into position information; a second sensor, detecting mechanical vibration generated in association with opening and closing of the ON-OFF valve; a reference position specification part, pre-storing, as reference position information, position information when vibration is detected by the second sensor; and a calibration processing part, when vibration is detected by the second sensor, executing calibration processing to reduce position measurement errors based on the position information obtained by the position information generation part and the reference position information.

### CROSS-REFERENCE TO RELATED APPLICATION

This application claims the priority benefit of Japan application serial no. 2024-063275, filed on Apr. 10, 2024. The entirety of the above-mentioned patent application is hereby incorporated by reference herein and made a part of this specification.

### BACKGROUND

### Technical Field

The disclosure relates to a position measuring device and method in which acceleration or angular velocity of a measurement target is subjected to integration and converted into position information.

### Related Art

A valve (for example, a control valve shown in FIG. 8) used in a petrochemical plant or the like requires particular attention to safety, and accordingly undergoes regular maintenance. The control valve shown in FIG. 8 includes a valve body 100 that opens and closes a passage through which fluid flows, a positioner 101 that converts input electrical signals into air pressure, and an operating device 102 that operates the valve body 100 according to the air pressure supplied from the positioner 101.

In a plant where many valves like that shown in FIG. 8 are installed, to improve maintenance work efficiency of the valves, there have been proposed a technology in which the occurrence of stick-slip in a sliding portion of a valve is detected (see Japanese Patent No. 3254624), a technology in which a hunting state of a valve is determined (see Japanese Patent No. 6200309), and a technology in which scale adhesion to a valve is detected (see Japanese Patent No. 6216633), and so on.

On the other hand, as a different type of valve from the control valve in which an opening degree can be continuously changed, there is an ON-OFF valve that can only take two positions, namely fully open and fully closed. An ON-OFF valve 200 shown in FIG. 9 uses a ball valve, and is of a structure in which a ball 201 being a valve body is sandwiched by a seat ring 202 called a ball seat. The valve can be opened or closed by rotating a valve stem 203 by 90 degrees using an operating device 204. Depending on the type, there are also valves in which the rotation is performed by an angle other than 90 degrees.

As a failure detection method using the ON-OFF valve as a diagnosis target, there has been proposed a technology in which failure is detected by using a time required for opening and closing of the valve as a diagnostic index, or by using a maximum operating speed and minimum operating speed as diagnostic indices (see Japanese Patent No. 7265328). There have also been proposed technologies in which supplied air pressure for operating an ON-OFF valve is monitored (see Japanese Patent Laid-Open Nos. H7-119862 and H11-210921).

It is desired that a diagnosis of ON-OFF valves be applied to many ON-OFF valves already installed in a plant. From the viewpoint of ON-OFF valve diagnostic methods, an opening degree measuring method may be considered in which an acceleration sensor or angular velocity sensor (gyro sensor) or the like is installed on a valve stem, and acceleration or angular velocity is subjected to integration and converted into position information. That is, it is preferable to retrofit an opening degree meter equipped with the acceleration sensor or angular velocity sensor to an ON-OFF valve already installed in a plant, so as to perform valve diagnosis.

In the case of converting the integration of acceleration or angular velocity into position information, even if the acceleration or angular velocity can be measured with accuracy within an acceptable range without failure, position measurement errors (opening degree measurement errors in the above example) due to accumulation of minute errors (such as rounding errors in a processor, or noise components) cannot be ignored. Due to these errors, the reliability of the entire diagnostic or control system may be reduced. Since there are various installation environments and installation angles of valves, it is difficult to use geomagnetism or gravitational acceleration for calibration. Although it is possible to perform calibration by attaching another device to a position other than the valve stem to which the acceleration sensor or angular velocity sensor is attached, the implementation is difficult because of various valve shapes. Accordingly, it is desired to reduce position measurement errors by a position measuring device alone.

Such problems are not limited to the opening degree measurement of ON-OFF valves, and may happen in many cases where a measuring method is adopted that converts the integration of acceleration or angular velocity into position information.

### SUMMARY

A position measuring device includes: a first sensor, configured to measure acceleration or angular velocity of a measurement target; a position information generation part, configured to integrate the acceleration or the angular velocity with respect to time and convert the acceleration or the angular velocity into position information; a second sensor, configured to detect mechanical vibration generated in association with movement of the measurement target; a reference position specification part, configured to pre-store, as reference position information, position information of the measurement target when vibration is detected by the second sensor; and a calibration processing part, configured to, in response to detection of vibration by the second sensor, execute calibration processing to reduce position measurement errors based on the position information obtained by the position information generation part as well as the reference position information.

A position measuring method includes: measuring acceleration or angular velocity of a measurement target; integrating the acceleration or the angular velocity with respect to time and converting the acceleration or the angular velocity into position information; detecting mechanical vibration generated in association with movement of the measurement target; and, referring to a reference position specification part that pre-stores, as reference position information, position information of the measurement target when the mechanical vibration is detected, and, in response to detection of the mechanical vibration, executing calibration processing to reduce position measurement errors based on the position information obtained by the integrating of the acceleration or the angular velocity with respect to time and the converting of the acceleration or the angular velocity into position information as well as the reference position information.

### BRIEF DESCRIPTION OF THE DRAWINGS

FIG. 1 is a block diagram showing a configuration of a position measuring device according to a first embodiment of the disclosure.

FIG. 2 is a flowchart describing an operation of the position measuring device according to the first embodiment of the disclosure.

FIG. 3 is an instrumentation diagram of an ON-OFF valve.

FIG. 4 is a diagram describing calibration processing performed by a calibration processing part according to the first embodiment of the disclosure.

FIG. 5 is a block diagram showing a configuration of a position measuring device according to a second embodiment of the disclosure.

FIG. 6 is a flowchart describing an operation of the position measuring device according to the second embodiment of the disclosure.

FIG. 7 is a block diagram showing a configuration example of a computer that implements the position measuring device according to the first and second embodiments of the disclosure.

FIG. 8 is a diagram showing an example of a control valve.

FIG. 9 is a diagram showing an example of an ON-OFF valve.

### DESCRIPTION OF THE EMBODIMENTS

In the disclosure, in a position measuring device and method in which acceleration or angular velocity of a measurement target is subjected to integration and converted into position information, position measurement errors (drifts) due to accumulation of minute errors can be reduced.

A position measuring device of the disclosure includes: a first sensor, configured to measure acceleration or angular velocity of a measurement target; a position information generation part, configured to integrate the acceleration or the angular velocity with respect to time and convert the acceleration or the angular velocity into position information; a second sensor, configured to detect mechanical vibration generated in association with movement of the measurement target; a reference position specification part, configured to pre-store, as reference position information, position information of the measurement target when vibration is detected by the second sensor; and a calibration processing part, configured to, when vibration is detected by the second sensor, execute calibration processing to reduce position measurement errors based on the position information obtained by the position information generation part as well as the reference position information.

In one configuration example of the position measuring device of the disclosure, the reference position information is pre-stored for each movement direction of the measurement target, and the calibration processing part executes calibration processing using the reference position information corresponding to the movement direction of the measurement target.

In one configuration example of the position measuring device of the disclosure, the first sensor measures acceleration or angular velocity of a valve stem of an ON-OFF valve. The position information generation part converts the acceleration or the angular velocity into an opening degree of the ON-OFF valve, the opening degree being the position information. The second sensor detects mechanical vibration generated when the ON-OFF valve moves in a direction from fully closed to fully open, or mechanical vibration generated when the ON-OFF valve moves in a direction from fully open to fully closed. The reference position specification part pre-stores the reference position information during an opening operation and the reference position information during a closing operation of the ON-OFF valve. The calibration processing part executes calibration processing using the reference position information during the opening operation when the ON-OFF valve is in the opening operation, and executes calibration processing using the reference position information during the closing operation when the ON-OFF valve is in the closing operation

In one configuration example of the position measuring device of the disclosure, the second sensor detects vibration generated by actuation of a first limit switch that turns on when the ON-OFF valve reaches the vicinity of a fully open position, or vibration generated by actuation of a second limit switch that turns on when the ON-OFF valve reaches the vicinity of a fully closed position.

A position measuring method of the disclosure includes: a first step, in which acceleration or angular velocity of a measurement target is measured; a second step, in which the acceleration or the angular velocity is subjected to integration with respect to time and converted into position information; a third step, in which mechanical vibration generated in association with movement of the measurement target is detected; and a fourth step, in which a reference position specification part is referred to that pre-stores, as reference position information, position information of the measurement target when the mechanical vibration is detected, and, when the mechanical vibration is detected, calibration processing is executed to reduce position measurement errors based on the position information obtained by the second step as well as the reference position information.

According to the disclosure, by providing the second sensor, the reference position specification part and the calibration processing part, position measurement errors (drifts) due to accumulation of minute errors can be reduced by the position measuring device alone.

### Principle of the Invention

Generally, in the case where a measurement error is a “deviation” called a drift, it is sufficient to appropriately execute calibration. However, in the case of an ON-OFF valve as described above, in order to obtain information on a reference position corresponding to fully closed (having an opening degree of 0%) or fully open (having an opening degree of 100%), it is necessary to add a function to detect fully closed/fully open. Even if that function is already provided, it is necessary to add a signal line to acquire the detected information. Accordingly, since a position measurement error cannot be corrected by merely retrofitting an opening degree meter to the ON-OFF valve, simple retrofitting is less likely to be achieved.

The present inventor focused on the fact that a position measurement target involves mechanical operation. That is, in the case of the ON-OFF valve as described above, residual vibration generated when a valve stem moves from fully open to fully closed and stops, or vibration generated by a pre-equipped mechanical limit switch for fully closed/fully open detection, occurs as a highly reproducible phenomenon at a specific reference position even if not exactly at a fully closed/fully open position.

It is conceived that by detecting this vibration with a vibration sensor and using the position as a pre-defined reference position at the time of vibration detection, calibration that reduces position measurement errors (drifts) can be executed. That is, without the need to newly add the signal line or the like, a configuration can be achieved in which a position measuring device (opening degree meter) equipped with an acceleration sensor or angular velocity sensor and a vibration sensor is simply retrofitted to an ON-OFF valve.

The disclosure is applicable to any case where a measurement method that converts the integration of acceleration or angular velocity into position information is adopted, and the position measurement target involves reproducible vibration due to some cause.

### First Embodiment

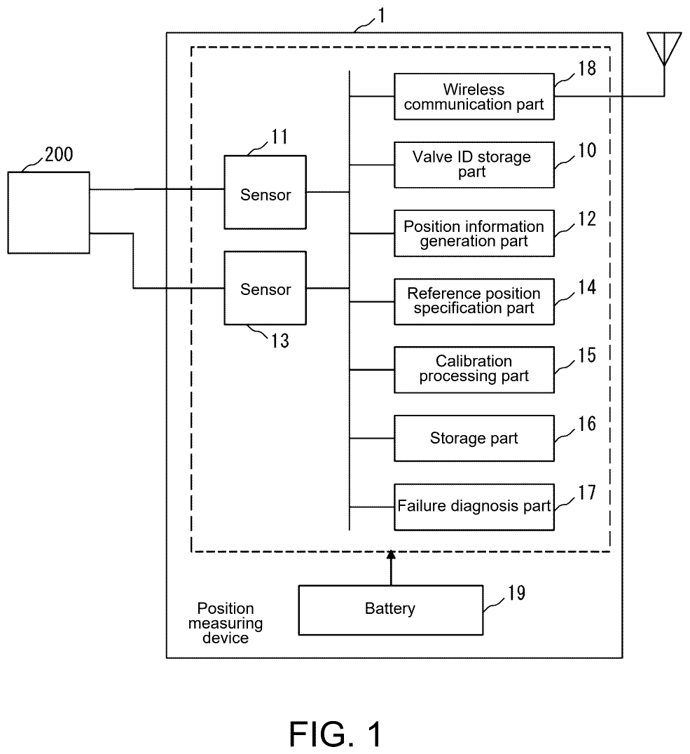

Hereinafter, embodiments of the disclosure will be described with reference to the drawings. FIG. 1 is a block diagram showing a configuration of a position measuring device according to a first embodiment of the disclosure. A position measuring device 1 is a battery-powered wireless opening degree meter, and includes: a valve ID storage part 10, storing an ID (identification information) unique to an ON-OFF valve 200 to which the position measuring device 1 is attached; a sensor 11, measuring acceleration or angular velocity of a valve stem of the ON-OFF valve 200; a position information generation part 12, integrating the acceleration or angular velocity measured by the sensor 11 and converting the acceleration or angular velocity into position information; a sensor 13, detecting mechanical vibration generated in association with opening and closing of the ON-OFF valve 200; a reference position specification part 14, pre-storing, as reference position information, position information when vibration is detected by the sensor 13; a calibration processing part 15, when vibration is detected by the sensor 13, executing calibration processing to reduce position measurement errors based on the position information obtained by the position information generation part 12 as well as the reference position information; a storage part 16, storing position information; a failure diagnosis part 17, calculating an index of a change leading to a failure of the ON-OFF valve 200 based on the position information, and executing a failure diagnosis of the ON-OFF valve 200 based on the index; a wireless communication part 18, wirelessly transmitting data to a valve maintenance support device (not shown); and a battery 19, supplying power to each part of the position measuring device 1.

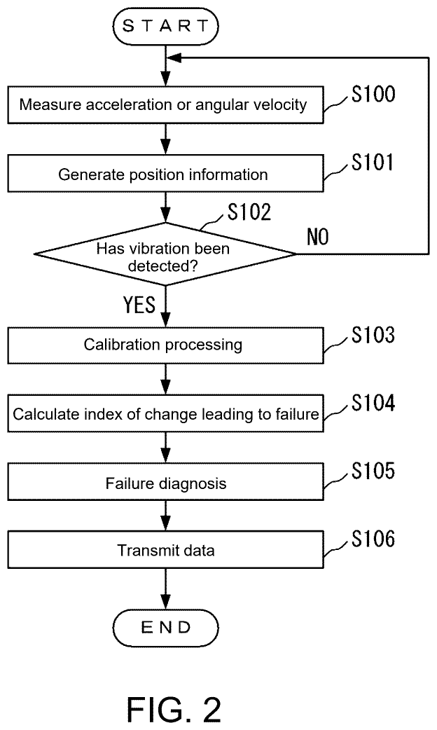

FIG. 2 is a flowchart describing an operation of the position measuring device 1. The sensor 11 of the position measuring device 1 attached to the ON-OFF valve 200 serving as a measurement target measures the acceleration or angular velocity of the valve stem of the ON-OFF valve 200 (step S100 in FIG. 2). For example, in the case where the ON-OFF valve 200 is of a type that is fully opened or fully closed by up and down movement of the valve stem, it is preferable to measure the acceleration of the valve stem; in the case where the ON-OFF valve 200 is of a type such as a ball valve that is fully opened or fully closed by rotation of the valve stem, it is preferable to measure the angular velocity of the valve stem.

The position information generation part 12 integrates the acceleration or angular velocity measured by the sensor 11 with respect to time and converts the acceleration or angular velocity into position information (step S101 in FIG. 2). Specifically, in the case where the acceleration of the valve stem is measured by the sensor 11, the position information generation part 12 performs second-order integration on the acceleration with respect to time, thereby converting the acceleration into position information (displacement) of the valve stem. In the case where the angular velocity is measured by the sensor 11, the position information generation part 12 performs first-order integration on the angular velocity with respect to time, thereby converting the angular velocity into position information (angular displacement).

An initial value (100% or 0%) of the opening degree when the ON-OFF valve 200 stops at the fully open or fully closed position is known. An operating direction (from fully open to fully closed or from fully closed to fully open) of the ON-OFF valve 200 can be determined from the displacement or angular displacement of the valve stem. Accordingly, during an opening operation of the ON-OFF valve 200, the position information generation part 12 may convert a position (displacement or angular displacement) of the valve stem into the opening degree of the ON-OFF valve 200 using the initial value (0%) of the opening degree and a known relationship between linear displacement of the valve stem and change in opening degree of the ON-OFF valve 200 or a known relationship between angular displacement of the valve stem and change in opening degree of the ON-OFF valve 200. During a closing operation of the ON-OFF valve 200, the position information generation part 12 may convert the position (displacement or angular displacement) of the valve stem into the opening degree using the initial value (100%) of the opening degree and a known relationship between linear displacement of the valve stem and change in opening degree of the ON-OFF valve 200 or a known relationship between angular displacement of the valve stem and change in opening degree of the ON-OFF valve 200.

The sensor 11 and the position information generation part 12 periodically perform the processing of steps S100 and S101. By repeating the processing of steps S100 and S101, time series data of the opening degree of the ON-OFF valve 200 is stored in the storage part 16. The time series data of the opening degree calculated by the position information generation part 12 is denoted as D(t).

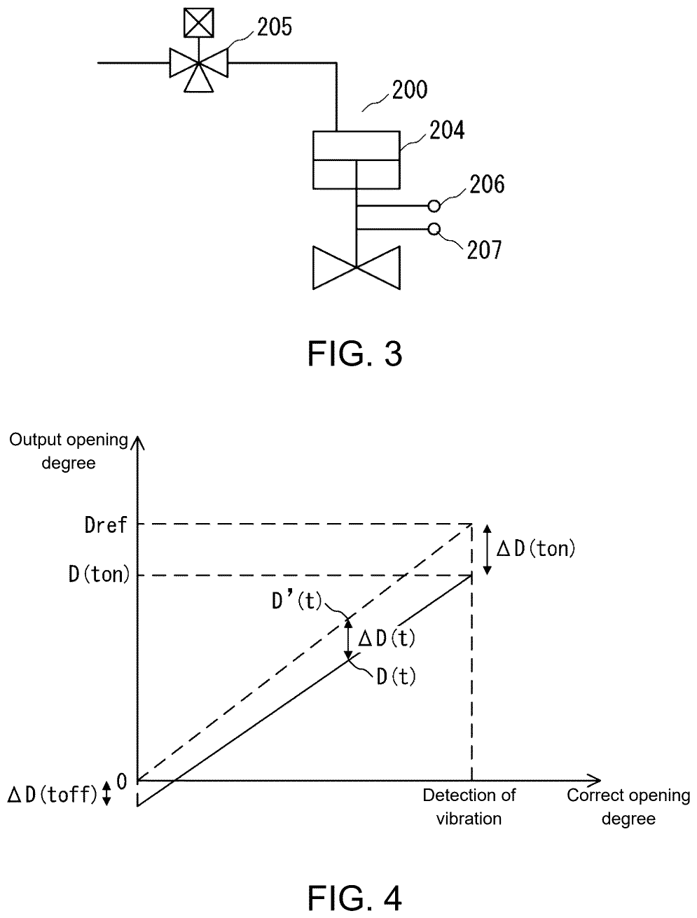

Next, the sensor 13 detects mechanical vibration generated in association with the opening and closing of the ON-OFF valve 200 (step S102 in FIG. 2). The better part of the ON-OFF valve 200 is instrumented as shown in FIG. 3. Operating device air may be supplied to an operating device 204 of the ON-OFF valve 200 via an electromagnetic valve 205. An open state of the ON-OFF valve 200 is detected by a limit switch 206, and a closed state of the ON-OFF valve 200 is detected by a limit switch 207. When the limit switch 206 turns on during the opening operation of the ON-OFF valve 200, mechanical vibration is generated by actuation of the limit switch 206. Similarly, when the limit switch 207 turns on during the closing operation of the ON-OFF valve 200, mechanical vibration is generated by actuation of the limit switch 207. The sensor 13 detects this vibration.

The sensor 13 may detect residual vibration generated when the valve stem of the ON-OFF valve 200 moves from fully open to fully closed or from fully closed to fully open and stops.

Next, the reference position specification part 14 pre-stores, as reference position information (reference opening degree), position information (opening degree of ON-OFF valve 200) of the valve stem when vibration is detected by the sensor 13. An operator who attaches the position measuring device 1 to the ON-OFF valve 200 may look up the reference position information (reference opening degree) by a calibration test during attachment and cause the reference position specification part 14 to store the reference position information (reference opening degree). The reference position information includes reference position information during the opening operation of the ON-OFF valve 200 and reference position information during the closing operation of the ON-OFF valve 200.

At the time point when the limit switch 206 turns on, there is a possibility that the ON-OFF valve 200 may not exactly be fully open (having an opening degree of 100%). However, it is sufficient to store, as the reference position information during the opening operation, a position (having an opening degree in the vicinity of 100%) in the vicinity of the fully open position when vibration due to the turning on of the limit switch 206 is detected. Similarly, at the time point when the limit switch 207 turns on, the ON-OFF valve 200 may not exactly be fully closed (having an opening degree of 0%). However, it is sufficient to store, as the reference position information during the closing operation, a position (having an opening degree in the vicinity of 0%) in the vicinity of the fully closed position when vibration due to the turning on of the limit switch 207 is detected.

When vibration is detected by the sensor 13, the calibration processing part 15 calibrates the time series data D(t) of the opening degree stored in the storage part 16 based on the reference position information (reference opening degree) stored in the reference position specification part 14 (step S103 in FIG. 2).

The operating direction (from fully open to fully closed or from fully closed to fully open) of the ON-OFF valve 200 can be determined from the displacement or angular displacement of the valve stem. Accordingly, it can also be determined which of the reference position information during the opening operation and the reference position information during the closing operation of the ON-OFF valve 200 should be used for calibration when vibration is detected by the sensor 13.

During the opening operation of the ON-OFF valve 200, the calibration processing part 15 calibrates, in the time series data D(t) of the opening degree calculated by the position information generation part 12, a value of the opening degree at the time point when vibration is detected by the sensor 13, as a value of the reference position information (reference opening degree in the vicinity of 100%) during the opening operation. Similarly, during the closing operation of the ON-OFF valve 200, the calibration processing part 15 calibrates, in the time series data D(t) of the opening degree calculated by the position information generation part 12, a value of the opening degree at the time point when vibration is detected by the sensor 13, as a value of the reference position information (reference opening degree in the vicinity of 0%) during the closing operation. In this way, by performing calibration processing, a position measurement error can be corrected. In FIG. 2, the calibration processing is described as a necessary condition for the next flow. However, the disclosure is not limited thereto. The calibration based on the reference position information (reference opening degree) may be appropriately executed, for example, only when a cumulative error due to integration exceeds an allowable value.

In this example, only drifts due to integration are assumed, and calibration is performed only using the value of the opening degree of either fully open or fully closed when vibration is detected by the sensor 13. However, if errors in the acceleration or angular velocity itself are also assumed, calibration may be performed using the opening degree at which vibration is detected by the sensor 13 in both cases of fully open and fully closed. As shown in FIG. 4, when the correct opening degree that should be detected based on the time series data D(t) of the opening degree is taken on the horizontal axis and the opening degree output including errors is taken on the vertical axis, if the reference position information (reference opening degree) is Dref and the value of the opening degree when vibration is detected by the sensor 13 at fully open is D(ton), an error in the opening degree when vibration is detected by the sensor 13 is ΔD(ton)−Dref−D(ton). Similarly, at fully closed, an error ΔD(toff) may be obtained. Accordingly, an error ΔD(t) at each opening degree can be calculated from ΔD(ton) and ΔD(toff). By adding, to the data D(t) of each detected opening degree, the error ΔD(t) at that opening degree, data D′(t) of the opening degree after calibration processing can be obtained. In this way, even if errors in the acceleration or angular velocity itself are included, the calibration processing part 15 is able to calibrate the opening degree when vibration is detected by the sensor 13.

In the above description, the calibration processing part 15 performs calibration processing at the time point when vibration is detected by the sensor 13. However, as described above, there is a possibility that the ON-OFF valve 200 may not be fully open or fully closed at the time point when vibration is detected by the sensor 13. Accordingly, even after the time point when vibration is detected by the sensor 13 and calibration processing is performed, the processing of steps S100 and S101 is continued. However, after the time point when calibration processing is performed, it is necessary for the position information generation part 12 to convert displacement or angular displacement to an opening degree using the value (reference opening degree in the vicinity of 100% or reference opening degree in the vicinity of 0%) of the reference position information as the initial value of the opening degree.

In the case where a state of 100% opening degree has continued for a certain period of time or more, the position information generation part 12 determines that the ON-OFF valve 200 has stopped at the fully open position, and resets the initial value of the opening degree to 100%. Similarly, in the case where a state of 0% opening degree has continued for a certain period of time or more, the position information generation part 12 determines that the ON-OFF valve 200 has stopped at the fully closed position, and resets the initial value of the opening degree to 0%.

Next, at a predetermined timing, the failure diagnosis part 17 of the position measuring device 1 calculates an index of a change leading to a failure of the ON-OFF valve 200 based on the time series data D′(t) of the opening degree after calibration processing (step S104 in FIG. 2), and executes a failure diagnosis of the ON-OFF valve 200 based on the index (step S105 FIG. 2). The timing at which the failure diagnosis part 17 executes the processing is, for example, a timing at which the ON-OFF valve 200 stops. However, the processing may be executed at a different timing.

For example, the failure diagnosis part 17 uses a time required for opening and closing of the ON-OFF valve 200 as an index of a change leading to a failure (step S104). When the time required for opening and closing reaches or exceeds a predetermined diagnostic threshold, the failure diagnosis part 17 determines that there is a possibility that a failure may have occurred in the ON-OFF valve 200; when the time required for opening and closing is less than the diagnostic threshold, the failure diagnosis part 17 determines that the ON-OFF valve 200 is normal (step S105).

The wireless communication part 18 of the position measuring device 1 wirelessly transmits data which includes the valve ID stored in the valve ID storage part 10, the time series data of the opening degree after calibration processing, the index of the change leading to a failure, and a result of failure diagnosis by the failure diagnosis part 17 to a valve maintenance support device (not shown) (step S106 FIG. 2). The valve maintenance support device presents the received index and result of failure diagnosis to an operator.

The operation of the failure diagnosis part 17 in the present embodiment is an example, and other diagnoses may be performed. In the disclosure, the failure diagnosis part 17 is not an essential component. In the case where the failure diagnosis part 17 is not provided, it is sufficient that the wireless communication part 18 transmits the valve ID and the time series data of the opening degree after calibration processing.

### Second Embodiment

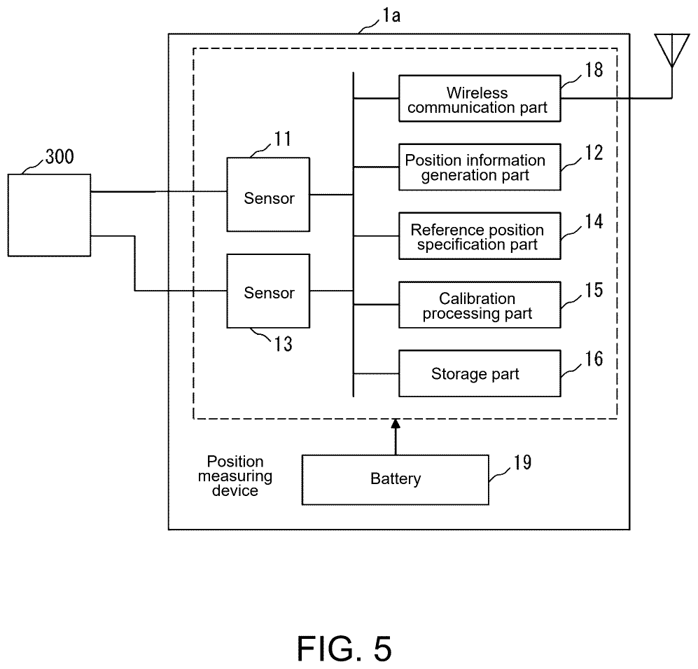

In the first embodiment, a battery-powered wireless opening degree meter is described as an example of the position measuring device. However, the disclosure may be applied to any position measuring device that converts acceleration or angular velocity of a measurement target into position information of the measurement target. FIG. 5 shows a generalized example of the position measuring device of the first embodiment. In the configuration of FIG. 5, a measurement target 300 is an object that moves linearly or performs rotational movement.

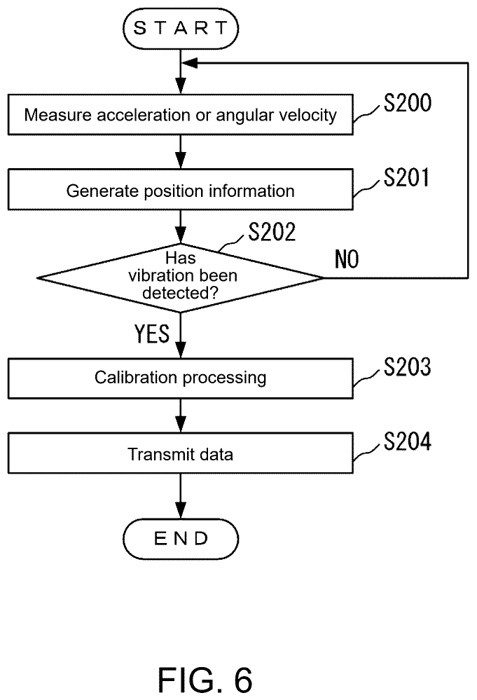

FIG. 6 is a flowchart describing an operation of a position measuring device 1a of the present embodiment. The sensor 11 of the position measuring device 1a attached to the measurement target 300 measures the acceleration or angular velocity of the measurement target 300 (step S200 in FIG. 6). In the case of the measurement target 300 that moves linearly, it is preferable to measure the acceleration of the measurement target 300; in the case of the measurement target 300 that performs rotational movement, it is preferable to measure the angular velocity of the measurement target 300.

The position information generation part 12 integrates the acceleration or angular velocity measured by the sensor 11 with respect to time and converts the acceleration or angular velocity into position information (step S201 in FIG. 6). Specifically, in the case where the acceleration of the measurement target 300 is measured by the sensor 11, the position information generation part 12 performs second-order integration on the acceleration with respect to time, thereby converting the acceleration into displacement of the measurement target 300. In the case where the angular velocity is measured by the sensor 11, the position information generation part 12 performs first-order integration on the angular velocity with respect to time, thereby converting the angular velocity into angular displacement.

Here, it is assumed that an initial position of the measurement target 300 when it stops is known. In the case of the measurement target 300 that moves linearly, the position information generation part 12 is capable of converting the displacement of the measurement target 300 into a position on a straight line using the initial position of the measurement target 300. In the case of the measurement target 300 that performs rotational movement, the position information generation part 12 is capable of converting the angular displacement of the measurement target 300 into a rotational position using the initial position of the measurement target 300.

The sensor 11 and the position information generation part 12 periodically perform the processing of steps S200 and S201. By repeating the processing of steps S200 and S201, time series data of the position of the measurement target 300 is stored in the storage part 16. The time series data of the position calculated by the position information generation part 12 is denoted as X(t).

Next, the sensor 13 detects mechanical vibration generated in association with the movement of the measurement target 300 (step S202 in FIG. 6). It is sufficient that the sensor 13, for example, detects residual vibration generated when the measurement target 300 moves and stops.

Next, the reference position specification part 14 pre-stores, as reference position information, position information of the measurement target 300 when vibration is detected by the sensor 13. An operator who attaches the position measuring device 1a to the measurement target 300 may look up the reference position information by a calibration test during attachment and cause the reference position specification part 14 to store the reference position information. The reference position information includes reference position information when the measurement target 300 moves in a first direction (for example, right direction or clockwise) and reference position information when the measurement target 300 moves in a second direction (for example, left direction or counterclockwise).

When vibration is detected by the sensor 13, the calibration processing part 15 calibrates the time series data X(t) of the position stored in the storage part 16 based on the reference position information stored in the reference position specification part 14 (step S203 in FIG. 6).

An operating direction (first direction or second direction) of the measurement target 300 can be determined from the displacement or angular displacement of the measurement target 300. Accordingly, it can also be determined which of the reference position information for the first direction and the reference position information for the second direction should be used for calibration when vibration is detected by the sensor 13.

When the measurement target 300 moves in the first direction, the calibration processing part 15 calibrates, in the time series data X(t) of the position calculated by the position information generation part 12, a position when vibration is detected by the sensor 13, as a value of the reference position information for the first direction. Similarly, when the measurement target 300 moves in the second direction, the calibration processing part 15 calibrates, in the time series data X(t) of the position calculated by the position information generation part 12, a position when vibration is detected by the sensor 13, as a value of the reference position information for the second direction. In FIG. 6, the calibration processing is described as a necessary condition for the next flow. However, the disclosure is not limited thereto. The calibration based on the reference position information may be appropriately executed, for example, only when a cumulative error due to integration exceeds an allowable value.

In this example, only drifts due to integration are assumed, and calibration is performed only using one reference position when vibration is detected by the sensor 13. However, if errors in the acceleration or angular velocity itself are also assumed, calibration may be performed using multiple positions where vibration is detected by the sensor 13. If the reference position information is Xref and the position when vibration is detected by the sensor 13 is X(ton), an error in the position when vibration is detected by the sensor 13 is ΔX(ton)=Xref−X(ton). Similarly, at another reference position, an error ΔD(toff) may be obtained. Accordingly, an error ΔX(t) at each position can be calculated from ΔX(ton) and AΔX(toff). By adding, to the data X(t) of each position, the error ΔX(t) at that position, data X′(t) of the position after calibration processing can be obtained. In this way, even if errors in the acceleration or angular velocity itself are included, the calibration processing part 15 is able to calibrate the position when vibration is detected by the sensor 13.

In the above description, the calibration processing part 15 performs calibration processing at the time point when vibration is detected by the sensor 13. However, there is a possibility that the measurement target 300 may not have reached a limit position at the time point when vibration is detected by the sensor 13. Accordingly, even after the time point when vibration is detected by the sensor 13 and calibration processing is performed, the processing of steps S200 and S201 is continued. However, after the time point when calibration processing is performed, it is necessary for the position information generation part 12 to convert displacement or angular displacement to the position of the measurement target 300 using the value of the reference position information as the initial position.

In the case where a state in which the measurement target 300 has reached a limit position in the first direction has continued for a certain period of time or more, the position information generation part 12 determines that the measurement target 300 has stopped, and resets the initial position to the limit position in the first direction. Similarly, in the case where a state in which the measurement target 300 has reached a limit position in the second direction has continued for a certain period of time or more, the position information generation part 12 determines that the measurement target 300 has stopped, and resets the initial position to the limit position in the second direction.

The wireless communication part 18 of the position measuring device 1a wirelessly transmits the time series data of the position of the measurement target 300 to the outside (step S204 in FIG. 6).

In this way, the disclosure can be applied to the position measuring device 1a that converts the integration of acceleration or angular velocity into position information.

In the first and second embodiments, since there is also a possibility of erroneously detecting vibration different from the vibration intended to be detected by the sensor 13, the calibration processing part 15 may, for example, determine whether the desired vibration corresponding to the reference position has been detected by recognizing a pattern of the vibration, and perform the calibration processing when it is determined that the desired vibration has been detected.

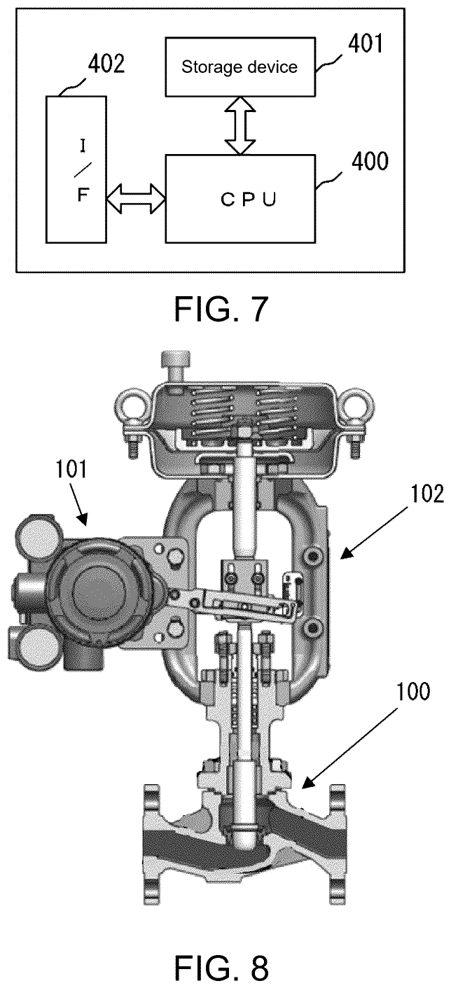

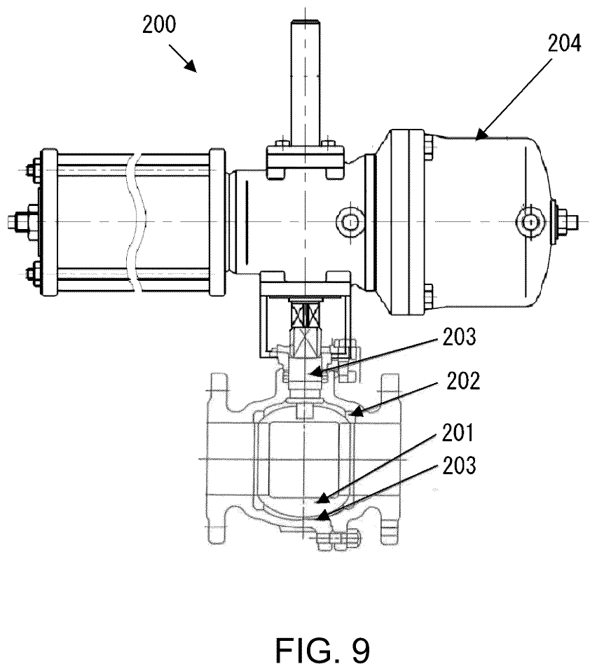

The valve ID storage part 10, position information generation part 12, reference position specification part 14, calibration processing part 15, storage part 16, failure diagnosis part 17, and wireless communication part 18 of the position measuring devices 1 and la described in the first and second embodiments can be implemented by a computer equipped with a central processing unit (CPU), a storage device and an interface, and a program that controls these hardware resources. A configuration example of this computer is shown in FIG. 7.

The computer includes a CPU 400, a storage device 401, and an interface device (abbreviated as I/F) 402. Hardware such as the sensors 11, 13 and the wireless communication part 18 are connected to the I/F 402. In such a computer, a program for implementing the disclosure is stored in the storage device 401. The CPU 400 executes the processing described in the first and second embodiments according to the program stored in the storage device 401.

The disclosure can be applied to technologies in which acceleration or angular velocity is subjected to integration and converted into position information.

What is claimed is:

1. A position measuring device comprising:
a first sensor, configured to measure acceleration or angular velocity of a measurement target;
a position information generation part, configured to integrate the acceleration or the angular velocity with respect to time and convert the acceleration or the angular velocity into position information;
a second sensor, configured to detect mechanical vibration generated in association with movement of the measurement target;
a reference position specification part, configured to pre-store, as reference position information, position information of the measurement target when vibration is detected by the second sensor; and
a calibration processing part, configured to, in response to detection of vibration by the second sensor, execute calibration processing to reduce position measurement errors based on the position information obtained by the position information generation part as well as the reference position information.

2. The position measuring device according to claim 1, wherein
the reference position information is pre-stored for each movement direction of the measurement target; and
the calibration processing part executes calibration processing using the reference position information corresponding to the movement direction of the measurement target.

3. The position measuring device according to claim 1, wherein
the first sensor measures acceleration or angular velocity of a valve stem of an ON-OFF valve;
the position information generation part converts the acceleration or the angular velocity into an opening degree of the ON-OFF valve, the opening degree being the position information;
the second sensor detects mechanical vibration generated when the ON-OFF valve moves in a direction from fully closed to fully open, or mechanical vibration generated when the ON-OFF valve moves in a direction from fully open to fully closed;
the reference position specification part pre-stores the reference position information during an opening operation and the reference position information during a closing operation of the ON-OFF valve; and
the calibration processing part executes calibration processing using the reference position information during the opening operation when the ON-OFF valve is in the opening operation, and executes calibration processing using the reference position information during the closing operation when the ON-OFF valve is in the closing operation.

4. The position measuring device according to claim 2, wherein
the first sensor measures acceleration or angular velocity of a valve stem of an ON-OFF valve;
the position information generation part converts the acceleration or the angular velocity into an opening degree of the ON-OFF valve, the opening degree being the position information;
the second sensor detects mechanical vibration generated when the ON-OFF valve moves in a direction from fully closed to fully open, or mechanical vibration generated when the ON-OFF valve moves in a direction from fully open to fully closed;
the reference position specification part pre-stores the reference position information during an opening operation and the reference position information during a closing operation of the ON-OFF valve; and
the calibration processing part executes calibration processing using the reference position information during the opening operation when the ON-OFF valve is in the opening operation, and executes calibration processing using the reference position information during the closing operation when the ON-OFF valve is in the closing operation.

5. The position measuring device according to claim 3, wherein
the second sensor detects vibration generated by actuation of a first limit switch that turns on when the ON-OFF valve reaches the vicinity of a fully open position, or vibration generated by actuation of a second limit switch that turns on when the ON-OFF valve reaches the vicinity of a fully closed position.

6. The position measuring device according to claim 4, wherein
the second sensor detects vibration generated by actuation of a first limit switch that turns on when the ON-OFF valve reaches the vicinity of a fully open position, or vibration generated by actuation of a second limit switch that turns on when the ON-OFF valve reaches the vicinity of a fully closed position.

7. A position measuring method comprising:
measuring acceleration or angular velocity of a measurement target;
integrating the acceleration or the angular velocity with respect to time and converting the acceleration or the angular velocity into position information;
detecting mechanical vibration generated in association with movement of the measurement target; and,
referring to a reference position specification part that pre-stores, as reference position information, position information of the measurement target when the mechanical vibration is detected, and, in response to detection of the mechanical vibration, executing calibration processing to reduce position measurement errors based on the position information obtained by the integrating of the acceleration or the angular velocity with respect to time and the converting of the acceleration or the angular velocity into position information as well as the reference position information.
